(19) United States
(12) Patent Application Publication
(10) Pub. No.: US 2015/0039644 A1
(43) Pub. Date: Feb. 5, 2015

(54) SYSTEM AND METHOD FOR PERSONALIZED RECOMMENDATION AND OPTIMIZATION OF PLAYLISTS AND THE PRESENTATION OF CONTENT

(71) Applicant: Mehul A. Trivedi, San Francisco, CA (US)

(72) Inventor: Mehul A. Trivedi, San Francisco, CA (US)

(73) Assignee: AliphCom, San Francisco, CA (US)

(21) Appl. No.: 14/452,496

(22) Filed: Aug. 5, 2014

Related U.S. Application Data
(60) Provisional application No. 61/862,265, filed on Aug. 5, 2013.

(51) Int. Cl. G06F 17/30; H04L 29/08

(52) U.S. Cl. CPC G06F 17/30053; H04L 67/22; G06F 17/3064
USPC 707/767

(57) ABSTRACT

The present disclosure relates to systems and methods for recommending and/or optimizing a presentation of content as a function of activity related to consumed content, and more particularly to analysis of content and related data as a criteria for forming specific playlists based on a larger selection of content, and arranging the order of content within a playlist to form, for example, personalized, curated collections of content (e.g., curated “playlists”). According to some examples, a flow includes receiving, at a processor, a request for a list identifying audio content items, and accessing consumption data indicative of audio content consumed by one or more media devices associated with a user. The flow can also include identifying one or more lists identifying subsets of audio content items, determining an order of presentation, and providing the processor with data representing the one or more modified lists responsive to the request.

### CROSS-REFERENCE TO RELATED APPLICATIONS

This application claims the benefit of U.S. Provisional Patent Application No. 61/862,265, filed with the U.S. Patent and Trademark Office on Aug. 5, 2013, and entitled, “System and Method for Personalized Recommendation and Optimization of Playlists,” which is incorporated herein by reference.

### FIELD

The present disclosure relates to systems and methods for recommending and/or optimizing a presentation of content as a function of activity related to consumed content, and more particularly to analysis of content and related data (e.g., previous consumption activity) as a criteria for forming specific playlists based on a larger selection of content, and arranging the order of content within a playlist to form, for example, personalized, curated collections of content (e.g., curated “playlists”).

### BACKGROUND

Access to digital media has become near ubiquitous and the amount of content to which users have access has been growing at an incredible pace. As a result, users increasingly rely on playlists as a way to organize and subdivide this content into more coherent and digestible chunks. Additionally, the advent of cloud storage and social networking has generated tremendous demand for the sharing of these playlists between people. However, as the number of playlists created, and subsequently shared, has grown, it has become increasingly difficult for users to filter through all of this content to find what is relevant to them.

The consumption of digital media by a user is happening across a large number of different services and across a number of different devices. This content may be stored locally or accessed via one of many different streaming services. Additionally, the format of the content may vary. For instance, a song may be played as an audio file or as a music video.

Thus, a need exists for improved methods and systems for recommending a presentation of grouped content, such as playlists of media content to users.

### SUMMARY

It can be desirable to implement a system that identifies and aggregates consumption activity, and uses it for improved content discovery. This allows a user to continue consumption over any number of devices and/or services, while still allowing a recommendation system to leverage that data. One exemplary aspect of the present disclosure is directed to a computer-implemented method to generate a recommended playlist that, for example, can be personalized to a user or the preferences of the user. The method includes receiving, at or within a computing device, a request for a playlist of audio content. A computing device can be, for example, a server computing device, a client computing device, a mobile computing device, etc. The method further includes accessing, via a computing device, consumption data indicative of audio content consumed by one or more users. The method further includes identifying one or more playlists based at least on the consumption data, and determining an order by which content is to be presented (e.g., a playback order) for the one or more playlists based on the consumption data. In some examples, the one or more playlists can be predefined or determined on-the-fly (i.e., real-time or near real-time). The method can further include providing the one or more playlists in response to the request.

In a particular implementation, a presentation order (e.g., a playback order) for one or more groups of content, such as playlists, can be formed by identifying known content in a group of content based on the consumption data, and identifying unknown content in the group of content based on the consumption data. Optionally, known content can be ordered, arranged, or ranked relative to unknown content in a playlist so that known (or more familiar) content can be presented to one or more users prior to the presentation of the unknown (or less familiar) content.

Another exemplary aspect of the present disclosure is directed to a computer-implemented method to generate a recommended playlist that, for example, can be personalized to the preferences of the user. The method can also include identifying and matching data representing content with media content and/or related data (e.g., metadata, etc.) stored in association with one or more computing devices to determine one or more identifiers for a media object.

Data representing the one or more identifiers can be used to correlate the content of any accessible group of content, such as any given playlist in, or accessible by, one or more systems (or devices) with the consumption activity of the user. A relevance of a collection of content can be computed by, for example, determining an aggregated score of relevance factors, whereby the aggregated score represents similarity of a playlist with consumption activity across one or more characteristics of content (e.g., the content contained within a playlist). In some examples, characteristics of content can include, but are not limited to, a specific piece of content itself (e.g., a title, spectral content, etc.), an author, genre, publishing date, data size, etc. Additional characteristics of content identified in relation to the consumption activity can also be used (e.g. time of consumption or presentation, frequency of consumption, additional activity performed with content, such as sharing or referencing in social media, etc.).

In some examples, a method can include categorizing, arranging, relating, and/or, for example, structuring a collection of content based on identified consumption activity and/or characteristics. To illustrate, consider that once a playlist of relevance has been identified, the order of content associated with the playlist can be optimized for the user based upon the relevance of each specific item (e.g., song) of content. In some examples, content most familiar to the user (as determined by an associated “relevance factor”) may be placed as a first item in a queue, therefore maximizing user comfort with the collection of content. Further, less familiar content or unknown content may be placed after, or interspersed between, the more familiar content, thereby providing a mechanism for discovering and presenting new content while minimizing user uncertainty as to whether the newly-discovered or presented content is acceptable or preferred by the user.

The present disclosure is also directed to systems, apparatus, non-transitory computer-readable media, devices, and user interfaces for providing personalized recommendations and optimizations for playlists.

These and other features are understood with reference to the following description and appended claims. The accompanying drawings, which are incorporated in and constitute a part of this specification, illustrate and describe various embodiments of the invention and, together with the description, serve to explain the principles of the embodiments.

### BRIEF DESCRIPTION OF THE DRAWINGS

A full and enabling disclosure of the present invention, including the best mode thereof, directed to one of ordinary skill in the art, is set forth in the specification, which makes references to the appended figures, which:

FIG. 1 is a functional block diagram depicting one or more computing devices configured to generate and recommend modified lists of content, according to some embodiments;

FIG. 2 depicts an example of a flow diagram for recommending a modified list of content items, such as a modified playlist, to a user, according to some embodiments;

FIG. 3 depicts an example of a computing system for recommending modified playlists, according to one or more embodiments;

FIG. 4 depicts an example of a consumption data identifier and a list identifier configured to generate recommended playlist data, according to some embodiments;

FIG. 5 depicts a functional block diagram illustrating operation of a relevance factor determinator and a relevance correlator, according some embodiments;

FIG. 6 depicts implementation of a list modifier to modify a playlist, according to some embodiments;

FIG. 7 depicts another example of a system, according to one or more embodiments; and

FIG. 8 illustrates an exemplary computing platform configured to provide personalized, modified playlists in accordance with various embodiments.

### DETAILED DESCRIPTION

Reference now will be made in detail to embodiments of the invention, one or more examples of which are described in association with the drawings. The examples are provided by way of explanation of the various embodiments, and do not limit the scope of the one or more embodiments. It is apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the various embodiments cover such modifications and variations as come within the scope of the appended claims and their equivalents.

Generally, the present disclosure is directed to systems and methods for analyzing consumption-related information describing the activities of consumption of content to generate, for example, recommend playlists that can be personalized to a user. Thus, playlists can be recommended to a user based on the user's consumption activity (e.g., previous consumption activity). Further, systems and methods can arrange the content in a group of content so as to structure the ordering of content within the recommended playlists. Such arrangements or ordering of content further optimize the consumption of the recommended playlists.

In particular, consumption data indicative of content (e.g., songs) consumed by a user can be identified and accessed by systems and methods described herein. Playlists (or other collections of content) with strong similarities to consumed content of a user can be identified, whereby an order of content of one or more playlists or other collection can be structured or restructured (or otherwise modified) based on user consumption patterns over one or more intervals of time. Thus, the systems and methods of the present disclosure can facilitate content consumption and discovery with minimal user input. As such, systems and methods can provide a user a satisfying consumption experience along with serendipitous discovery.

In some examples, recommendation systems and methods can be effective in the creation of a mixture of content familiar to the user, and optionally provide additional content that is related, but may be undiscovered by the user. As such, identified playlists can be structured or restructured (or otherwise formed or modified) to introduce or present a collection of content to a user by first playing content familiar to the user, and subsequently presenting less unfamiliar but potentially-relevant content. This allows a user to feel confidence and comfort in the relevance of a collection, while still providing an avenue for discovery.

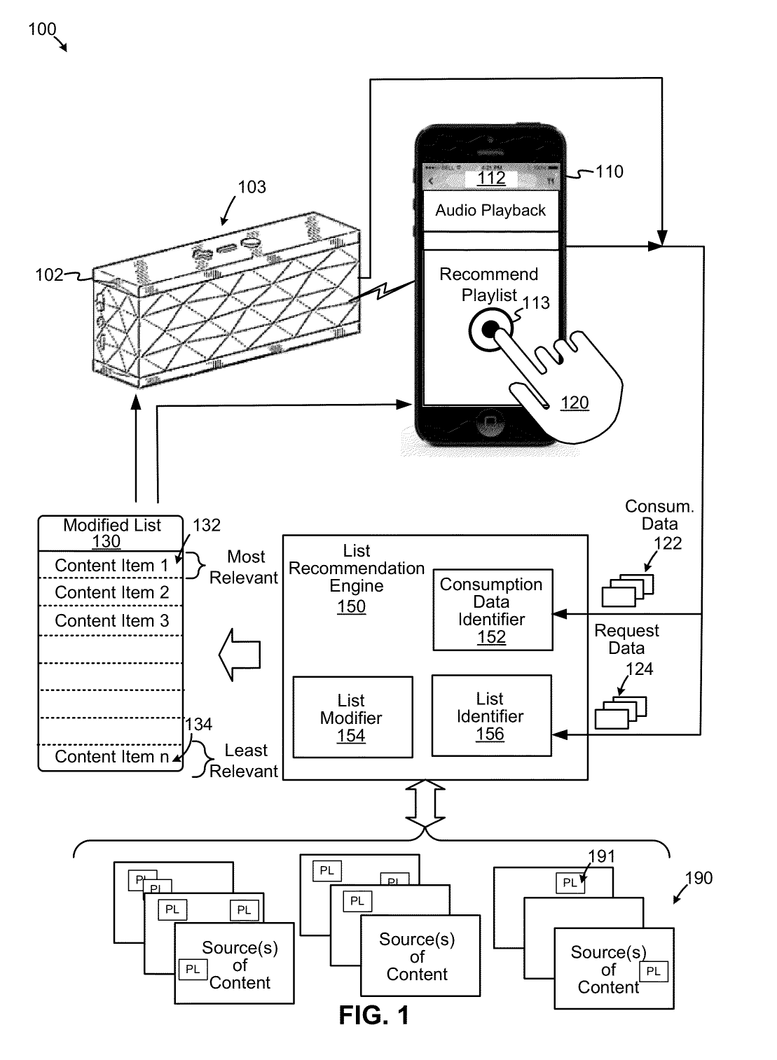

FIG. 1 is a functional block diagram depicting one or more computing devices configured to generate and recommend modified lists of content, according to some embodiments. Diagram 100 depicts a computing device 110 and a media device 102 configured to communicate with a list recommendation engine 150 for communicating modified lists of content, whereby the degree and types of modifications are functions of one or more preferences of a user. List recommendation engine 150 is shown to include a consumption data identifier 152, a list modifier 154, and a list identifier 156, according to some examples.

List recommendation engine 150 is configured to retrieve arrangements of content items from sources of content 190, such as sources of audio and/or data streaming. Examples of such arrangements include one or more playlists (“PL”) 191 of digitized audio that may be created by other users or entities, and may be based on references or links to content items hosted by a content streaming service. List recommendation engine 150 is configured to retrieve playlists 191 based on characteristics of user-preferred audio (e.g., in a user-created playlist or collection of audio), which can be described as consumption data 122. List recommendation engine 150 is further configured to adapt or modify a playlist 191 based on the similarities between one or more content items of playlist 191 and consumption data 122 for one or more content items associated with a user. Thus, list recommendation engine 150 is configured to generate a modified list 130 which may include a reordered list of content items from a retrieved playlist 191.

Diagram 100 depicts computing device 110 as a mobile computing device including an interface 112 and an application for accepting user input 113 by a user 120 to generate a request for recommended playlist. Also depicted in diagram 100 is a media device 102 that includes one or more buttons 103 (or inputs) as a user interface, the media device being any audio-producing or playback device, such as desktop audio system (e.g., a Jambox® manufactured by AliphCom of San Francisco, Calif., or a variant thereof). Computing device 110 and media device 102 can communicate data to present audio, such as a sequence of songs presented in accordance with modified list 130. Further, computing device 110 and media device 102 can store locally data representing content items or songs from which consumption data 122 can be extracted or derived.

Consumption data identifier 152 is configured to extract or otherwise receive consumption data 122 from devices 102 and 110, as well as other sources of content items, such as from a content streaming platform (i.e., a user may have an account with the content streaming service that hosts content item for consumption by the user). Further, consumption data identifier 152 is configured to characterize the content items or collections of content items associated with the user, whereby the characteristics of such content items may define a profile of a user's preference for certain types of songs or music.

Should the user desire to receive recommended playlists, request data 124 can be received from interface 112 into list recommendation engine 150. List identifier 156, responsive to request data 124, is configured to identify playlists 191 that are relevant to the user based on the user's preferences set forth by consumption data 122. Further, list modifier 154 is configured to restructure a playlist 191 or otherwise rearrange the presentation of the content items. For example, list modifier 154 can construct modified list 130 to include most relevant content items 132 at the beginning positions of playback, and may further dispose least relevant content items 134 at the latter portions of playback.

In view of the foregoing, the structures and/or functionalities of list recommendation engine 150 (and/or other elements described herein) can facilitate user preference-influenced modifications of one or more playlists for recommended consumption. In accordance with various embodiments, list recommendation engine 150 (and/or other elements described herein) can identify a mixture of content familiar to the user while presenting additional content that may be related to user's songs but otherwise are undiscovered. In particular, list recommendation engine 150 (and/or other elements described herein) can introduce a collection of content to a user by first playing content familiar to the user and subsequently presenting less unfamiliar, but potentially relevant content. Thus, the systems and methods of the present disclosure can facilitate content consumption and discovery with minimal amounts of user input or interaction. As such, systems and methods described herein can provide a user a satisfying consumption experience along with serendipitous discovery.

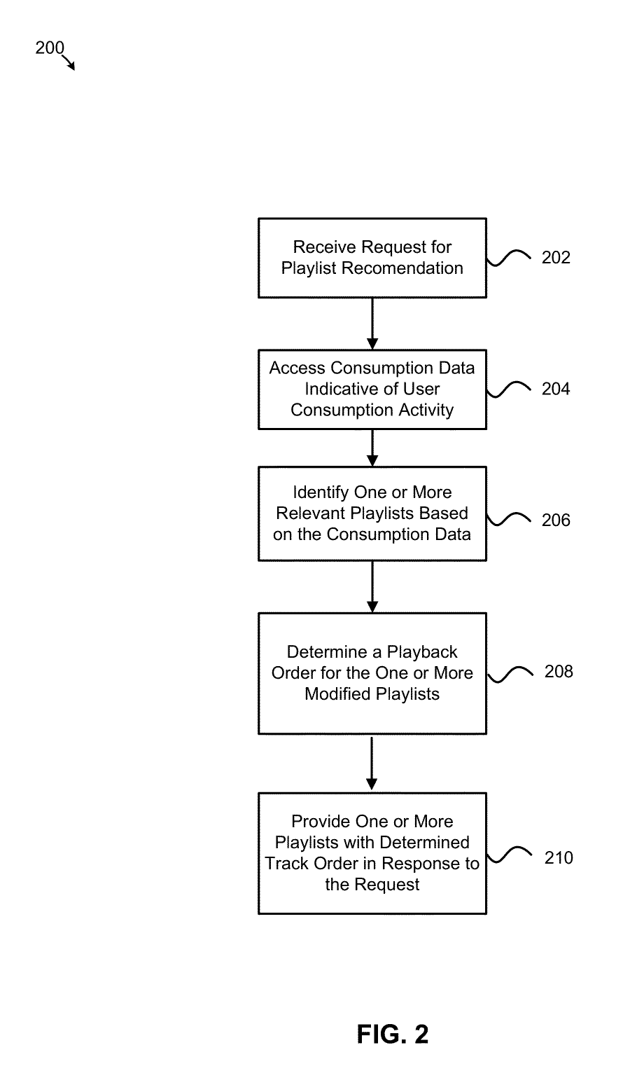

FIG. 2 depicts an example of a flow diagram 200 for recommending a modified list of content items, such as a modified playlist, to a user, according to some embodiments. Flow 200 can be implemented by any one or more suitable computing devices, such as a smartphone, tablet, digital music player, laptop, desktop, smart television, home theater system, or other computing device, including servers (e.g., web servers). Note that portions of flow 200 can be rearranged, omitted, adapted, modified, or expanded in various ways, according to various implementations.

At 202, flow 200 includes receiving a request for a recommendation of a list of content items, such as a playlist, or a collection of other content. In some examples, the request can be received at a server from a remote user device (e.g. a smartphone, tablet, personal computer, laptop, etc.) over a network, such as the Internet. In at least one example, the request can be received at the remote user device, such as a mobile computing device/phone or a media device. In some instances, the request can be for a recommendation of a playlist (e.g., a pre-existing or predefined playlist) that is available in a forum of publicly-available playlists or is otherwise available to the public at-large. Such playlists are generally developed to suit the creator's preferences rather than other individuals. For instance, a pre-defined playlist can be created and shared by a content streaming platform (e.g., Spotify™, Rdio™, iTunes™, etc.). Alternatively, predefined playlists can be user-created and shared via a social media platform or service social network communication (e.g., Facebook™, Twitter™, Flickr™, Pinterest™, etc.).

At 204, flow 200 can include accessing consumption data indicative of user consumption activity. For example, consumption data can include user content play history across any number of computing/media devices or services. For instance, consumption data can include data indicative of local data files played by a user on a user device, such as a mobile computing device or a media device. Further, consumption data can include data indicative of songs streamed by the user, for instance, from a content streaming platform.

The consumption data (and characteristics) can be identified and accessed using a number of different methods, or several in conjunction for additional accuracy. For instance, digital file metadata (such as an ID3 tag of an MP3 audio file, or other similar data arrangements that describe characteristics of audio or music or imagery), manual user tagging, or calculation using the raw audio data of the content (such a digitized summary of one or more audio waveforms) can be used to identify characteristics of consumption data. Further, consumption data, such as history or historic consumption data, from third party services (e.g., services including an on-demand streaming service or social network) may be obtained using, for example, an application programming interface (“API”) suitable to communicate with the third party services and/or systems. The content can be identified against one or more reference databases, so that device content can be identified against other device content, as well as content associated with an external system (such as a digital content delivery network archive, a music streaming service, etc.).

At 206, flow 200 can identify one or more relevant playlists of a number of accessible lists (e.g., predefined playlists) for recommending to a user in response to a request. The relevance of a specific playlist may be calculated using the correlation between “relevance factors” of content items in the specific playlist (e.g., considered either individually or aggregated) with that of a user's history describing consumption data. For instance, the relevance of an identified playlist, or other content collection, can be computed and distinguished by an aggregated score determined based on the relevance factors of the content in the playlist. As such, the aggregated score can represent a similarity of the playlist (or the associated content items) to the consumption data.

Relevance factors for items of content in a playlist can be determined based on factors that include, but are not limited to, a specific piece of content itself (e.g., whether specified by a content identifier, such as a title, or digital fingerprints, etc.), an author or artist name, a genre, a publishing and/or release date, and the like. Contextual characteristics of the consumption data, such as relating to activity or the context of playback, can also be used (e.g., date and/or time of consumption, a frequency of consumption, additional activity performed with content, such as sharing or referencing a content item or playlist via a social media service, etc.) to determine relevance factors associated with a particular playlist.

At 208, flow 200 can determine an order of presenting content items of a modified list (e.g., a playback order for one or more playlists). The order can be determined based on the user consumption data. For instance, the order of a playlist can be optimized for the user based upon the relevance (e.g., one or more relevance factors) of each specific piece of content in the playlist. Content most familiar to a user as, for example, determined by one or more relevance factors, can be placed as a first item in a queue, therefore maximizing user comfort with the collection. By contrast, less familiar content can be placed after, or interspersed between, the known content, thereby providing a mechanism for new content discovery while reducing uncertainty to a user whether they may not prefer to consume a content item.

At 210, flow 200 can caused the provisioning of data representing one or more modified lists to a processor in response to the request. Thus, one or more playlists with a determined playback order can be provided to a processor for presenting the content in response to a request. In one example, one or more modified playlists can be communicated from the server to the user device over a network, such as the Internet. The user device can then play the content according to the playback order through a suitable audio playback system, such as a mobile computing device or a media device.

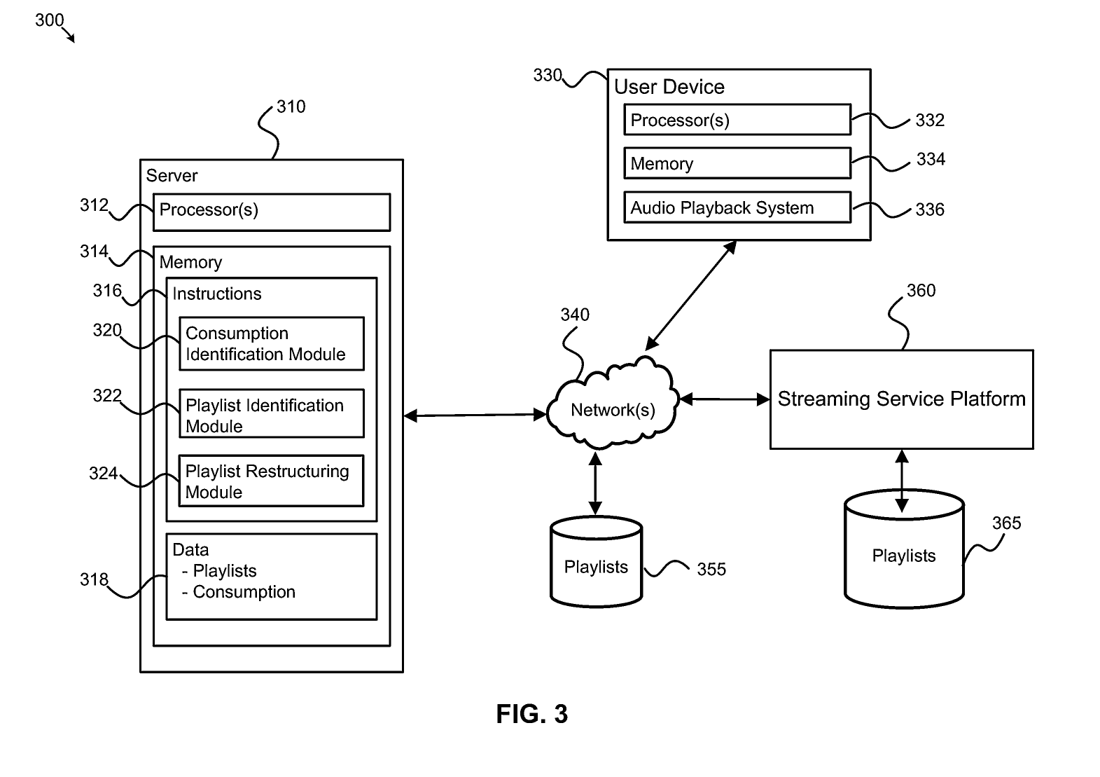

FIG. 3 depicts an example of a computing system for recommending modified playlists, according to one or more embodiments. System 300 includes a one or more computing devices, such as computing device 310 and computing device 330, which can be one or more of any device or machine capable of processing media, such as audio and/or video content. For instance, a computing device can include a smartphone, tablet, digital music player, laptop, desktop, smart television, home theater system, and other computing device. In the example shown, computing device 310 is a server including processor(s) 312 and a memory 314. Server 310 can also include a network interface (not shown) used to communicate with remote computing devices over one or more networks 340. The network interface can include any suitable components for interfacing with one more networks, including for example, transmitters, receivers, ports, controllers, antennas, or other suitable components.

In particular implementations, computing device 310 can be in communication with any other computing devices over network 340. For instance, computing device 310 can be in communication with computing device 330 (e.g., a mobile computing device/phone, a media device, etc.), a repository or database of playlists 355, and a streaming service platform 360 via network 340. Streaming service platform 360 can include remote media content libraries or music streaming services (e.g., Spotify™, Rdio™, iTunes™, etc.).

Processor(s) 312 can be any suitable processing device, such as a microprocessor. Memory 314 can include any suitable computer-readable medium or media, including, but not limited to, non-transitory computer-readable media, RAM, ROM, hard drives, flash drives, magnetic or optical media, or other memory devices. Memory 314 can store information accessible by processor(s) 312, including instructions 316 that can be executed by processor(s) 312. Memory 314 can also include data 318 that can be retrieved, manipulated, created, or stored by processor(s) 312. In some examples, data 318 can include lists (e.g., playlists), whether retrieved from third parties or user-generated, consumption data, and the like. Instructions 316 can be any set of instructions that, when executed by the processor(s) 312, cause any of processor(s) 312 to provide desired functionality. For instance, instructions 316 can be executed by processor(s) 312 to implement a consumption identification module 320, a playlist identification module 322, and a playlist restructuring module 324.

Consumption identification module 320 can be configured to identify consumption data associated with the user. For instance, consumption identification module 320 can identify user consumption data from the user device 330 and/or the streaming service platform 360. Further, consumption identification module 320 can access the user consumption data for extraction. In some embodiments, consumption identification module 320 is configured to characterize the consumption data to identify characteristic with which degrees of relevancy can be determined to describe the similarity between user consumption data and other playlist or content items.

Playlist identification module 330 can be configured to identify one or more lists (e.g., playlists) based on the consumption data. For instance, playlist identification module 330 can access playlists stored, for instance, in the playlist database 355 or a playlist database 365, which is associated with the streaming service platform 360, and identify playlists most relevant to the user's consumption data. In one example, playlist identification module 330 determines relevance factors (or values thereof) with which to compare to user consumption data.

Playlist restructuring module 324 can be configured to determine an order of presentation (e.g., a playback order) for the identified playlists based on the consumption data. For instance, the playlist restructuring module 324. For instance, playlist restructuring module 324 can be configured to order content items characterized as “familiar content” prior to (e.g., to be present earlier in a playlist) other content items characterized as “less familiar” content in a playlist.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

Similar to server 310, user device 330 can include a processor(s) 332 and a memory 334. User device 330 can also include, or can be coupled to one or more input/output devices. Computing devices 310 and 330 can include or can be coupled to one or more input/output devices. Input devices may correspond to one or more peripheral devices configured to allow a user to interact with computing devices 310 and 330. One exemplary input device can be a touch interface (e.g. a touch screen or touchpad) that allows a user to provide a user-generated trigger. The output devices can correspond to devices used to provide information to a user. One exemplary output device includes a suitable audio playback system 336 (e.g. speakers, headphones, radio transmitter) for playing audio to the user. An example of audio playback system 336 is a media device. Computing devices 310 and 330 can include or be coupled to other input/output devices, such as a keyboard, microphone, mouse, printer, and/or other suitable input/output devices.

Network(s) 340 can be can be any type of communications network, such as a local area network (e.g. intranet), wide area network (e.g. Internet), or some combination thereof. The network can also include direct connections between any of the computing devices. In general, communication between the computing devices can be carried via a network interface using any type of wired and/or wireless connection, using a variety of communication protocols, encodings or formats, and/or protection schemes.

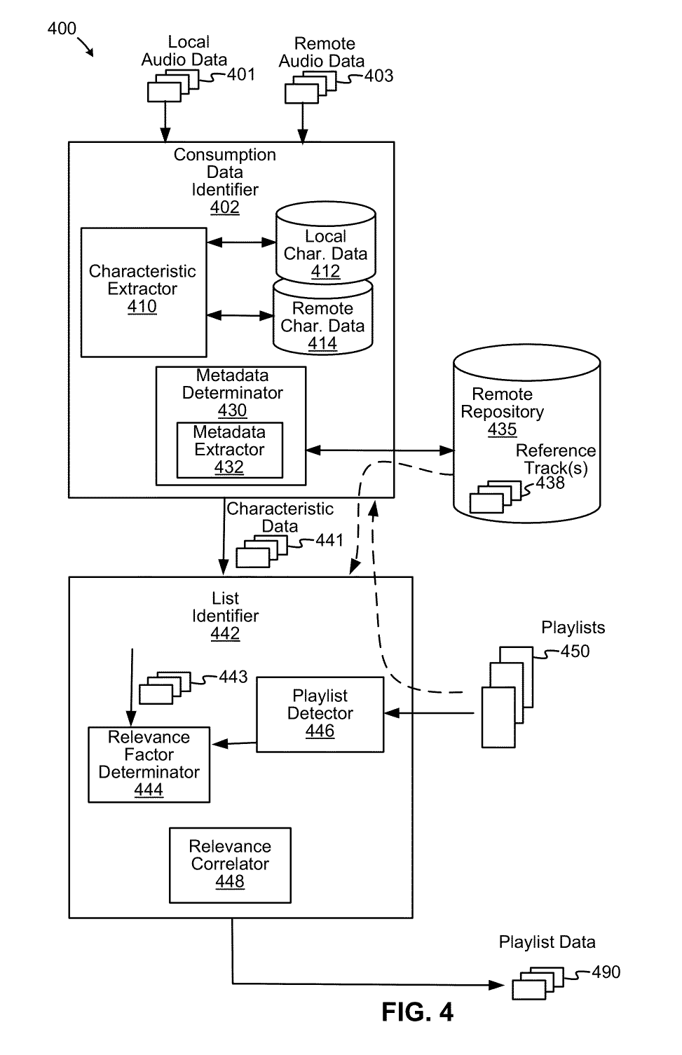

FIG. 4 depicts an example of a consumption data identifier and a list identifier configured to generate recommended playlist data, according to some embodiments. Diagram 400 depicts a consumption data identifier 402 including a characteristic extractor 410 and a metadata determinator 430 for determining characteristics of content items (e.g., tracks) to generate characteristic data 441. As shown, consumption data identifier 402 is configured to access or otherwise receive consumption data indicative of audio content consumed by one or more media devices associated with a user. In some cases, consumption data identifier 402 is configured to receive local audio data 401 that includes information regarding, for example, locally-stored content and related metadata. For example, local audio data 401 may include a history of consumption data associated with content items consumed by the one or more media devices. Historic local audio data 401, among other data, can be stored in local characteristic (“char.”) data repository 412. Consumption data identifier 402 is also configured to receive remote audio data 403 that includes information regarding, for example, remotely-stored content and related metadata (e.g., from a content streaming service). For example, remote audio data 403 may include a history of the consumption data associated with content items consumed from a content streaming service. Historic remote audio data 403, among other data, can be stored in local characteristic (“char.”) data repository 414. Historic audio data 401 and 403 may be stored so that consumption data identifier 402 can continuously (e.g., aperiodically or otherwise) evaluate and reevaluate (i.e., re-characterize) the consumption data associated with a user's collection of content items. For example, if a track is deemed highly relevant to a user during one interval of time, that same track may be re-characterized as less relevant if the user “skips” over the playback of the track over another interval of time.

In some embodiments, consumption data identifier 402 can be configured to generate characteristic data 441 to include values describing one or more the following characteristics: a content identifier (e.g., a title), an artist name, a genre, an album, a release date, or other characteristics (e.g., ID3 tag data). Characteristic data 441 can also include historic characteristics, such as a last time a track was played (or each time and date the track is played), a frequency in which a track or playlist is played, other activity data values (e.g., a number of times a track is shared via a social networking service), etc. In some embodiments, characteristic data 441 includes one or more relevance factors for the consumption data against which other relevance factors associated the one or more lists is correlated.

Metadata determinator 430 is configured to determine metadata associated with one or more audio tracts associated with audio data 401 and 402. In some examples, metadata determinator 430 can identify whether an audio track is equivalent to a reference track 438 disposed in remote repository 435. Further, metadata determinator 430 includes a metadata extractor 432 is configured to extract metadata information from reference track 438, or from metadata information associated with audio tracks. In operation, metadata determinator 430 is configured to identify content against one or more reference databases, so that device content can be identified against other device content, as well as content associated with an external system (such as a digital content delivery network archive, a music streaming service, etc.).

Further to FIG. 4, list identifier 442 is configured to identify one or more lists identifying subsets of audio content items based on the consumption data, and includes a relevance factor determinator 444, a playlist detector 446, and a relevance correlator 448. In one embodiment, playlist detector 446 is configured to detect playlists 450, and to access playlists 450 to receive information describing content items associated therewith.

Relevance factor determinator 444 is configured to receive consumption data 443 (e.g., values of characteristics or relevance factors for content items or tracks associated with a user). Relevance factor determinator 444 is configured to determine a relevance factor for playlist 549, such as an aggregated score, based on the consumption data, where the relevance factor indicative of a degree of similarity of a playlist to the consumption data. In some examples, relevance factor determinator 444 is configured to determine relevance factors (and values thereof) for each content item or track. According to some embodiments, relevance factor determinator 444 is configured to determine a content identifier (e.g., a title), an artist name, a genre, an album, a release date, or other characteristics, as well as a last time a track was played (or each time and date the track is played), a frequency in which a track or playlist is played, other activity data values (e.g., a number of times a track is shared via a social networking service), etc.

In some embodiments, a relevance factor can be represented by a value associated with an attribute of a content item (e.g., a song or other audio). The value can be expressed numerically or alpha-numerically. The value can indicate a range of values describing an attribute, or can indicate true or false to describe whether an attribute is present or not for one or more content items or a playlist. The relevance factors can have any values and can be used in any way to correlate the consumption data against relevant factors with playlists to determine a degree of similarity between the two.

Relevance correlator 448 is configured to identify data 490 representing a subset of playlists from playlists 450 based on the relevance factor(s). In one example, relevance correlator 448 can correlate one or more relevance factor associated with at least one playlist to a representation characterizing the consumption data. The representation can include data describe characteristics of the consumption data that may be the same types as the relevance factor(s).

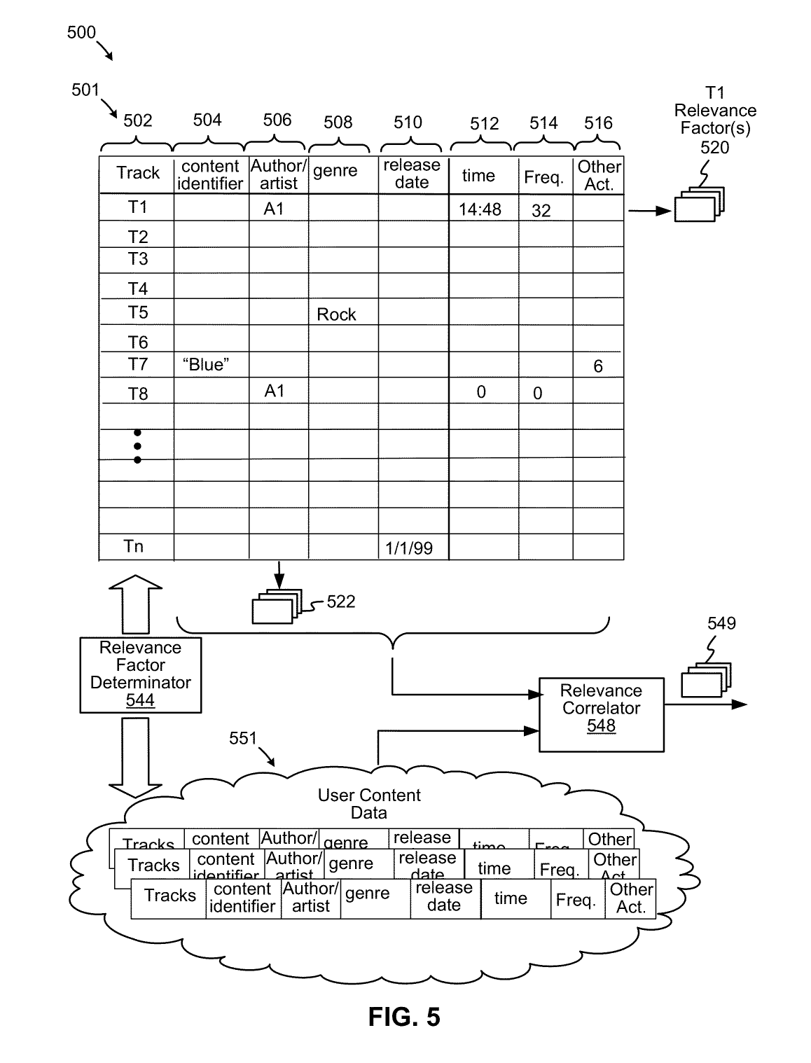

FIG. 5 depicts a functional block diagram illustrating operation of a relevance factor determinator and a relevance correlator, according some embodiments. Diagram 500 includes a representation 501 of relevance factors for a playlist (e.g., a predefined playlist from a third-party), which, according to one example, includes data generated by relevance factor determinator 544. As shown, playlist representation 501 identifies a track 502, such as tracks, T1, T2, T3, . . .Tn, and associated relevant factors. In the example shown, the relevant factors for playlist representation 501 includes a content identifier 504, an artist name 506, a genre 508, a release date 510, one or more times 512 at which a track was played, a frequency of playback 514, and data 516 representing other activities, such as an activity performed with the content, such as sharing or referring the content via social media networking service.

As shown, track T7 is associated with a title “Blue” for a song identifier 504. Tracks T1 and T2 performed by a commonly-named artist, A1. Track T5 has a value “Rock” as genre 508, whereas track Tn has a value “1/1/99” indicating a Jan. 1, 1999 release date. Track T1 was last played at 14:48 for time 512 and 32 times as a frequency 514, whereas track T8 was not played (e.g., 0 for time 512 and 0 for frequency 514). Further, track T7 has been “shared” (e.g., re-tweeted) 6 times for “other activity” 516.

Relevance factor determinator 544 is configured to access user content data 551, which includes consumption data and associated characteristics data describing user-related content and playlists. In some examples, user content data 551 can be structured similarly as representation 501 so that relevance correlator 548 can correlate portions of user content data 551 to portions of relevance factors in representation 501. Further, values for relevance factors can be determined in a number of ways. In some cases, relevance factor values 520 can be determined for each of the tracks. An example of a relevance factor value 520 includes a vector including a sequence of relevance factors 504 to 516. Multiple vectors can be compared against each other to determine matches or degrees of similarity (or dissimilarity). Also, relevance factors 520 can include any logical, numerical, or alphanumerical representation. In some cases, relevance factors 522 represent an aggregate value for artists' names over the playlist (e.g., the aggregate value can be represented by a vector, or can be derived or calculated to be any other symbolic representation). Relevance correlator 548 can generate data 548 expressing a degree of similarity between content items in user content data 551 and playlist representation 501. The degree of similarity can be used to determine which recommendations playlists are to be presented to a user for consumption. Alternatively, relevance correlator 548 can correlate an aggregate relevance score for representation 501 against an aggregate score for user content data 551 (e.g., an aggregate score for a user-generated playlist) to determine a degree of similarity or relevance as expressed by data 549.

To illustrate one example in which relevance correlator 540 operates, consider the following. Relevance correlator 548 can determine the degree of similarity of a playlist based on a range of matching characteristics between the playlist and the consumption data. As such, consider that relevance correlator 548 detects that track T1 by author/artist 506 forms part of user content data 551, and that same track T1 with the same author is disposed in part of a playlist associated with representation 501. Further, relevance correlator 548 detects that user plays track T1 regularly based on relevance factor “freq.” 514, whereas the user has yet to play track T8 (e.g., frequency of playback is 0). In some examples, relevance earlier 548 increases the relevancy for track T8 relative to other tracks in the playlist is preferred by the user. Thus, selection of either track T8 or the associate playlists provides the user with a serendipitous opportunity to consume audio content that the user likely will enjoy. As there is at least one link to track T8, this track may be deemed as “familiar” or of content that is “familiar” to the user.

Note that the operation of relevance factor determinator 544 and relevance correlator 548 are merely examples of a number of ways to perform the functionalities described herein, and the description of relevance factor determinator 544 and relevance correlator 548 is not intended to be limiting.

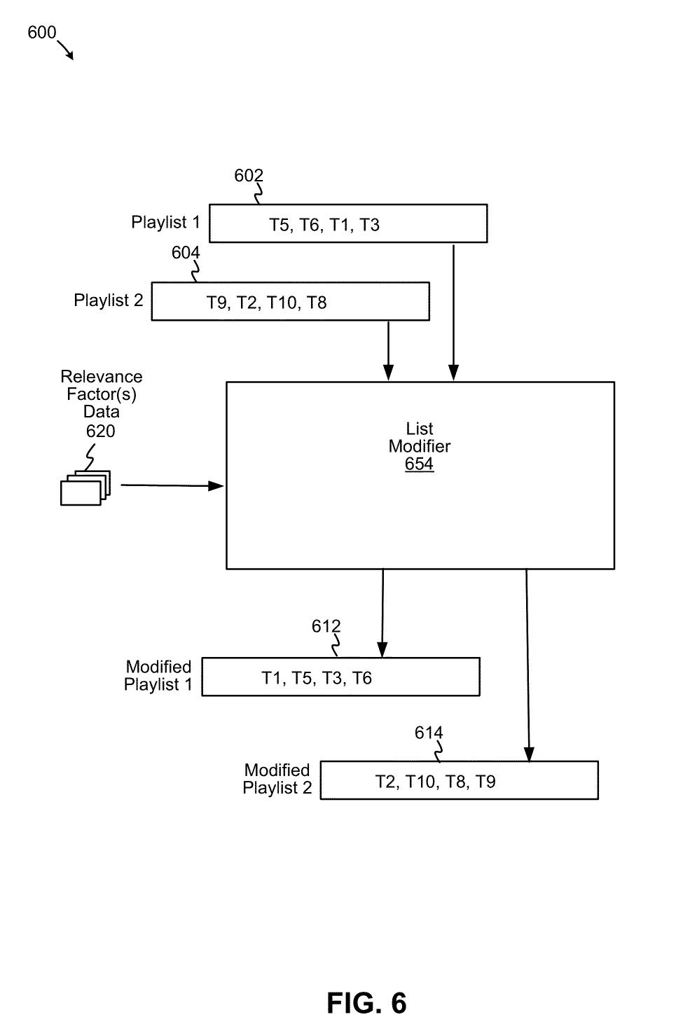

FIG. 6 depicts implementation of a list modifier to adapt a playlist, according to some embodiments. Diagram 600 depicts a list modifier 654 that is configured to order (or re-order) a presentation of audio content. For example, a list modifier 654 can be configured to identify a first subset of the audio content as “known content” in a list (e.g., a playlist) as a function of on the consumption data (e.g., a degree of similarity thereto), to identify a second subset of the audio content as “unknown content” in the list based on the consumption data, and to order or rearrange at least one item from the first subset of the known content to proceed during presentation at least one item from the second subset of the unknown content in the list. In some embodiments, list modifier 654 identifies known content by, for example, identifying a threshold value of a subset of the consumption data representing an item of content having a characteristic linked to a prior-consumed content item by the one or more media devices. For example, a threshold value can be set to indicate a number of links or associations of a content item or a playlist to user-related content. For example, if two to three tracks of a playlist include a least one match (e.g., similar artists, similar genre, similar frequency of play, etc.) as a threshold value, then those two to three tracks may be classified as “known content,” whereas other tracks that do not have at least one match may be classified as “unknown content.” Note that the threshold value can be of any number of matches or can be expressed in terms of degrees or a range of similar values (e.g., rather than match/no match determinations).

To illustrate operation of list modifier 654, consider the following example. A user listens to local file (“LF”) on a first device (“D1”), and also listens to remote file (“RF1”) 1 and remote file (“RF2”) via a content streaming service (“CSS”). Device D1 can transmit or provide local file, LF, and related metadata to a server or a processor. The server or processor can be configured to identify the local file LF as track “T1” by artist A1. Further, the server or processor is configured to use an API from the content streaming service (“CSS”) to access previous listens (e.g., historic data) to identify remote files RF1 and RF2 as tracks “T2” and “T3,” respectively. Note that in some cases, relevance factor data 620 can be used by list modifier 654 to order a presentation or playlist based on, for example, and relevance factor for each track of the playlist, whereby most relevant tracks are disposed near the beginning of playback and least relevant tracks disposed near the end of playback.

Next, consider that the user requests a new playlist recommendation.

Responsive to the request, server or processor can detect playlists P1 and P2 (e.g., publicly-available playlists hosted by third party entities). Playlist (“P1”) 602 includes tracks T1 and T3, and additional unknown tracks T5 and T6, whereby playlist P1 has the following playback order: [T5, T6, T1, T3]. Playlist (“P2”) 604 includes tracks T2 and T8, which is a track by artist A1, in addition to unknown tracks T9 and TI0. Playlist (“P2”) 604 has the following playback order: [T9, T2, T10, T8].

List modifier 654 (operating independently or interactively with the server or processor) can be configured to optimize an order of presentation of content items (e.g., tracks) in playlists P1 and P2 to a user. For example, consider that list modifier 654 can modify playlist P1 such that a modified playlist 612 has a playback order of: [T1, T5, T3, T6]. Note that unknown track T5 is arranged near the beginning to introduce the user serendipitously to newly-discovered content that a user may enjoy. List modifier 654 can modify playlist P2 so that a modified playlist 614 has a playback order of: [T2, T10, T8, T9]. Note that the server or processor can incorporate track T1 metadata in playlist P1 representation and T2 metadata for playlist P2.

Further, consider that a user listens to modified playlist (“P2”) 612. In particular, the user listens to track T1, skips track T5, then listens to tracks T2 and T6. Device D1 sends consumption activity data to the server or a process for updating characteristics related thereto. The server or processor incorporates the new consumption activity data to increase relevance of one or more playlists including track T6 and to decrease the relevance of one or more playlists including track T5.

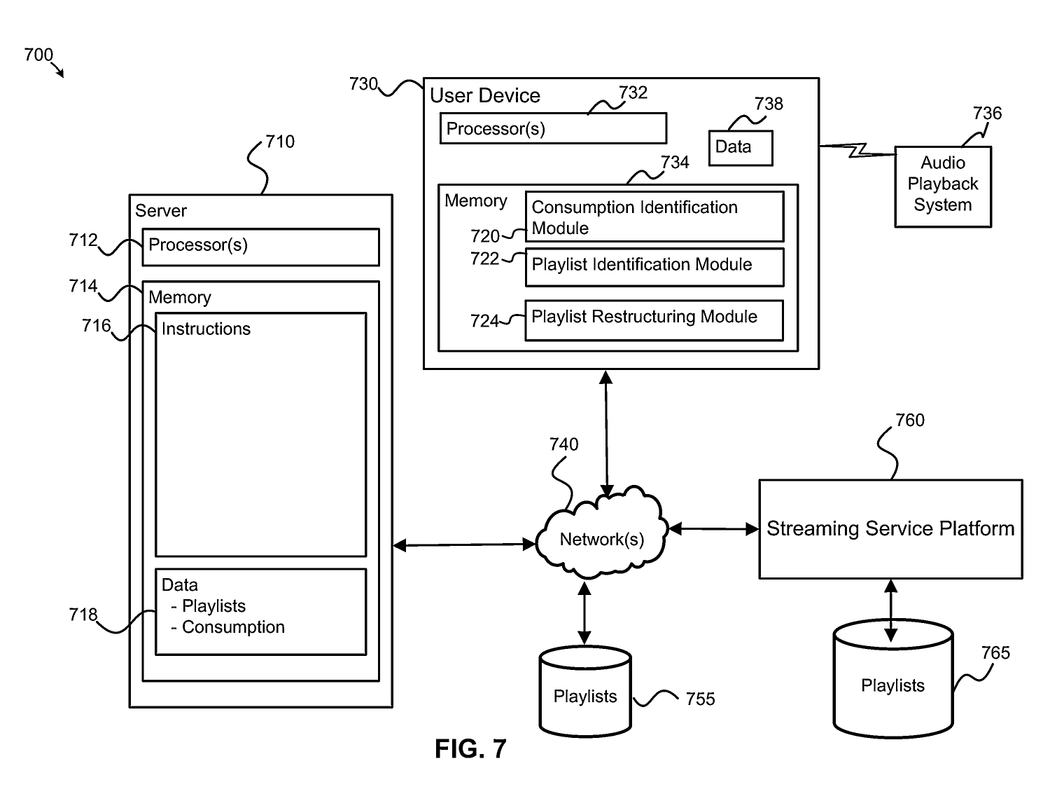

FIG. 7 depicts another example of a system, according to one or more embodiments. System 700 includes a computing device 710, such as a server, and a computing device 730, such as a user device. As shown, computing device 710 can include a processor(s) 712 and a memory 714 for storing instructions 716 and data 718 (e.g., playlist data, consumption data, etc.). Similarly, computing device 730 can include a processor(s) 732 and a memory 734, which can store executable instructions, and data 738, which can include data similar to data 718. As shown one or more of a consumption identification module 720, a playlist identification module 722, and a playlist restricting module 724 to implement one or more of the attendant functionalities described herein. Computing device 730 can include, or can be configured to communicate with, an audio playback system 735, which can be implemented as a media device. Computing devices 710 and 730 can also include a network interface (not shown) used to communicate with remote computing devices over a network 740.

In particular implementations, computing devices 710 and 730 can be in communication with a remote server 750, such as a streaming service platform 760, via network 740. Streaming service platform 760 can include, or be in communication with, a content delivery service, such as Spotify™, Rdio™, iTunes™, etc., which includes audio data representing content items (e.g., songs) and metadata in repository 765. Database 765 can include media for serving via network 742 to remote devices and associated metadata. Computing devices 710 and 730 can also access playlist and/or content item data in any third party database, such as database 755. In particular implementation, a user device implemented as computing device 730 can access content (e.g., streamed audio content) from remote server 710, streaming service platform 760, or from data 718 or 738. Instructions can be any set of instructions that, when executed by the processor(s) 732, cause any of processor(s) 732 to provide desired functionality. For instance, instructions 716 can be executed by processor(s) 732 to implement consumption identification module 720, playlist identification module 722, and playlist restricting module 724.

Note that in the system shown, computing devices 710 and 730 include hardware, software, and/or logic configured to implement the modules shown in FIG. 7. In various other implementations, one or more modules of device 730 can be disposed in server 710, and one or more modules of server 710 can be disposed in user device 730. In other implementations, any of the modules (or portions thereof) can be distributed among any of devices within or without system 700

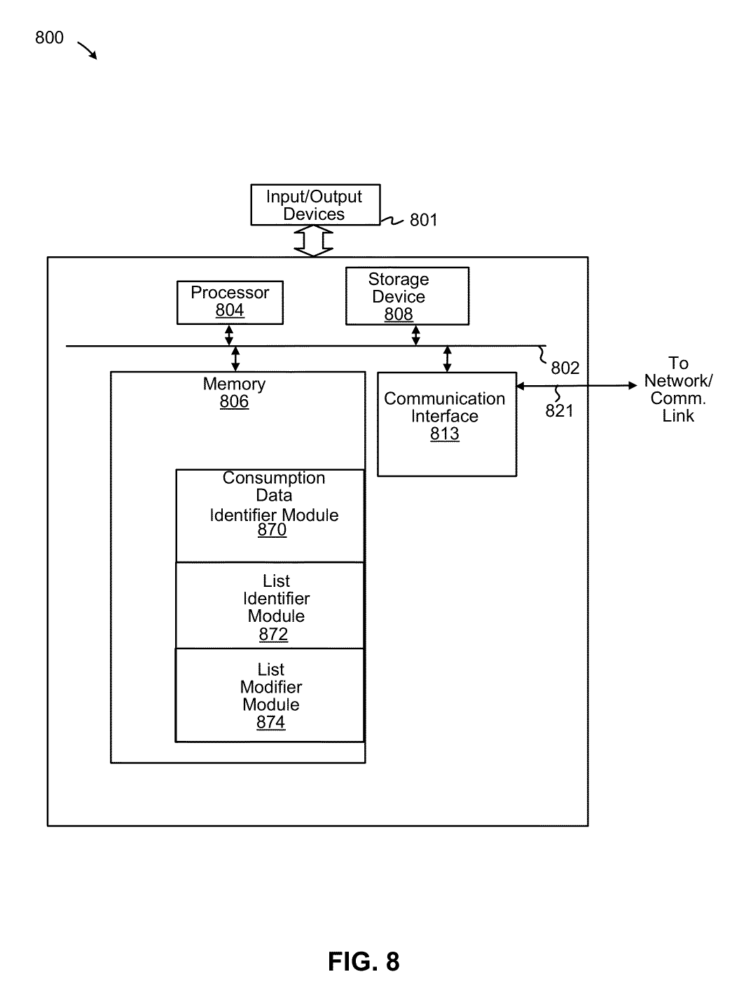

FIG. 8 illustrates an exemplary computing platform configured to provide personalized, modified playlists in accordance with various embodiments. In some examples, computing platform 800 may be used to implement computer programs, applications, methods, processes, algorithms, or other software to perform the above-described techniques.

In some cases, computing platform can be disposed in wearable device or implement, a mobile computing device, or any other device.

Computing platform 800 includes a bus 802 or other communication mechanism for communicating information, which interconnects subsystems and devices, such as processor 804, system memory 806 (e.g., RAM, etc.), storage device 8012 (e.g., ROM, etc.), a communication interface 813 (e.g., an Ethernet or wireless controller, a Bluetooth controller, etc.) to facilitate communications via a port on communication link 821 to communicate, for example, with a computing device, including mobile computing and/or communication devices with processors. Processor 804 can be implemented with one or more central processing units (“CPUs”), such as those manufactured by Intel® Corporation, or one or more virtual processors, as well as any combination of CPUs and virtual processors. Computing platform 800 exchanges data representing inputs and outputs via input-and-output devices 801, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 800 performs specific operations by processor 804 executing one or more sequences of one or more instructions stored in system memory 806, and computing platform 800 can be implemented in a client-server arrangement, peer-to-peer arrangement, or as any mobile computing device, including smart phones and the like. Such instructions or data may be read into system memory 806 from another computer readable medium, such as storage device 808. In some examples, hard-wired circuitry may be used in place of or in combination with software instructions for implementation. Instructions may be embedded in software or firmware. The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks and the like. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal.

In some examples, execution of the sequences of instructions may be performed by computing platform 800. According to some examples, computing platform 800 can be coupled by communication link 821 (e.g., a wired network, such as LAN, PSTN, or any wireless network) to any other processor to perform the sequence of instructions in coordination with (or asynchronous to) one another. Computing platform 800 may transmit and receive messages, data, and instructions, including program code (e.g., application code) through communication link 821 and communication interface 813. Received program code may be executed by processor 804 as it is received, and/or stored in memory 806 or other non-volatile storage for later execution.

In the example shown, system memory 806 can include various modules that include executable instructions to implement functionalities described herein. In the example shown, system memory 806 includes a consumption data identifier module 870, a list identifier module 872, and a list modifier module 874, any of which can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a consumption data identifier module, a list identifier module, and/or a list modifier module, or any one or more of their components (or any other structure/function described herein), or any process or device described herein, can be in communication (e.g., wired or wirelessly) with a mobile device, such as a mobile phone or computing device, or can be disposed therein. In some cases, a consumption data identifier module, a list identifier module, and/or a list modifier module, or any one or more of their components (or any other structure/function or any process or device described herein), can provide at least some of the structures and/or functions of any of the features described herein. As depicted in FIG. 1 and/or subsequent figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a consumption data identifier module, a list identifier module, and/or a list modifier module, or any one or more of their components, any of its one or more components, or any process or structure/device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, a consumption data identifier module, a list identifier module, and/or a list modifier module, including one or more other components, or any process or device described herein, can be implemented in one or more computing devices that include one or more circuits. Thus, at least one of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive. While the present subject matter has been described in detail with respect to specific exemplary embodiments and methods thereof, it is appreciated that those skilled in the art, upon attaining an understanding of the foregoing may readily produce alterations to, variations of, and equivalents to such embodiments. Accordingly, the scope of the present disclosure is by way of example, rather than by way of limitation, and the subject disclosure does not preclude inclusion of such modifications, variations and/or additions to the present subject matter is readily apparent to one of ordinary skill in the art.

What is claimed:

1. A computer-implemented method, comprising:
receiving, at a processor of a computing device, a request for data representing a list identifying audio content items;
accessing, with the computing device, consumption data indicative of audio content consumed by one or more media devices associated with a user;
identifying one or more lists identifying subsets of audio content items based on the consumption data;
determining an order of presentation for the one or more lists based on the consumption data to form one or more modified lists; and
providing the processor with data representing the one or more modified lists in response to the request.

2. The computer-implemented method of claim 1, wherein identifying the consumption data indicative of the audio content comprises:
accessing data representing a first history of the consumption data associated with content items consumed by the one or more media devices.

3. The computer-implemented method of claim 1, wherein identifying the consumption data indicative of the audio content comprises:
accessing data representing a second history of the consumption data associated with content items consumed from a content streaming service.

4. The computer-implemented method of claim 1, wherein identifying the consumption data further comprises:
determining one or more relevance factors for the consumption data against which other relevance factors associated the one or more lists are correlated.

5. The computer-implemented method of claim 1, wherein identifying the one or more lists based comprises:
accessing a plurality of playlists;
determining a relevance factor for the plurality of the playlists based on the consumption data, the relevance factor indicative of a degree of similarity of a playlist to the consumption data; and
identifying a subset of playlists from the plurality of playlists based on the relevance factor.

6. The computer-implemented method of claim 5, wherein determining the relevance factor comprises:
identifying characteristics of the audio content of the playlists including one or more of a content identifier, an author, a genre, and/or a release date.

7. The computer-implemented method of claim 5, wherein determining the relevance factor comprises:
identifying contextual characteristics of the audio content including a time of consumption, a frequency of consumption, and other activity performed with the content.

8. The computer-implemented method of claim 7, wherein the other activity comprises sharing or referring the audio content via a social media service.

9. The computer-implemented method of claim 5, wherein identifying the subset of playlists comprises:
correlating the relevance factor of at least one playlist to a representation characterizing the consumption data.

10. The computer-implemented method of claim 5, wherein the degree of similarity of the playlist is a range of matching characteristics between the playlist and the consumption data.

11. The computer-implemented method of claim 1, wherein determining the order of presentation for the one or more lists comprises:
identifying a first subset of the audio content as known content in the list based on the consumption data;
identifying a second subset of the audio content as unknown content in the list based on the consumption data; and
ordering at least one item from the first subset of the known content to proceed during presentation at least one item from the second subset of the unknown content in the list.

12. The computer-implemented method of claim 11, wherein identifying the first subset of the audio content as known content comprises:
identifying a threshold value of a subset of the consumption data representing an item of content having a characteristic linked to a prior-consumed content item by the one or more media devices.

13. The computer-implemented method of claim 1, further comprising:
causing presentation of the in a media device according to the order of presentation.

14. A system comprising:
a memory comprising:
executable instructions to implement consumption data identifier module configured to characterize consumption data indicative of audio content consumed by one or more media devices associated with a user; and
executable instructions to implement a list identifier module configured to one or more lists identifying subsets of audio content items based on the consumption data;
executable instructions to implement a list modifier module configured to determine an order of presentation for the one or more lists to form one or more modified lists; and
a processor configured to execute the executable instructions to implement the consumption data identifier module, the list identifier module, and the list modifier module, the processor further configured to receive data representing the one or more modified lists in response to a request.

15. The system of claim 14, wherein the executable instructions to implement the consumption data identifier module comprise:
executable instructions to access data representing a first history of the consumption data consumed by the one or more media devices.

16. The system of claim 14, wherein the executable instructions to implement the consumption data identifier module comprise:
executable instructions to access data representing a second history of the consumption data consumed from a content streaming service.

17. The system of claim 14, wherein the executable instructions to implement the list identifier module comprises:
executable instructions to access a plurality of playlists;
executable instructions to determine a relevance factor for the plurality of the playlists based on the consumption data, the relevance factor indicative of a degree of similarity of a playlist to the consumption data; and
executable instructions to identify a subset of playlists from the plurality of playlists based on the relevance factor.

18. The system of claim 17, wherein the executable instructions to determine the relevance factor comprise:
executable instructions to identify characteristics of the audio content of the playlists including one or more of a content identifier, an author, a genre, and/or a release date.

19. The system of claim 17, wherein the executable instructions to determine the relevance factor comprise:
executable instructions to identify contextual characteristics of the audio content including a time of consumption, a frequency of consumption, and other activity performed with the content.

20. The system of claim 14, wherein the executable instructions to implement the list modifier module comprises:
executable instructions to identify a first subset of the audio content as known content in the list based on the consumption data;
executable instructions to identify a second subset of the audio content as unknown content in the list based on the consumption data; and
executable instructions to order at least one item from the first subset of the known content to proceed during presentation at least one item from the second subset of the unknown content in the list.
